(19) United States
(12) Patent Application Publication
(10) Pub. No.: US 2002/0163908 A1
(43) Pub. Date: Nov. 7, 2002

(54) Apparatus, and associated method, for synchronizing operation of codecs operable pursuant to a communicaton session

(76) Inventors: Ari Lakaniemi, Helsinki (FI); Janne Parantainen, Helsinki (FI); Shkumbin Hamiti, Espoo (FI); Timo Rantalainen, Helsinki (FI); Heikki Einola, Helsinki (FI)

Correspondence Address: Docket Clerk, P.O. Box 802432, Dallas, TX, 75380, US

(21) Appl. No.: 09/850,559

(22) Filed: May 7, 2001

(51) Int. Cl. H04J 3/06

(52) U.S. Cl. 370/350; 370/503

(57) ABSTRACT

Apparatus, and an associated method, for facilitating synchronization of the operational codec modes of communication stations which communicate pursuant to a communication session. Signaling is provided to indicate allowed AMR (adaptive multi rate) codec modes to optimize speech connections in a GSM/EDGE radio access network (GERAN). RTP messages are defined, such as defining new message types or new field extensions in RTP messages to identify the codec modes.

The present invention relates generally to a manner by which to synchronize operation of codecs at sending and receiving communication stations operable in a communication system, such as a third-generation, cellular communication system, pursuant to a communication session. More particularly, the present invention relates to an apparatus, and an associated method, by which to communicate indicia associated with an active codec-mode set pursuant to which codecs of the communication stations are operable, thereby to facilitate communications between communication stations pursuant to a communication session.

### BACKGROUND OF THE INVENTION

Advancements in communication technologies have permitted the introduction, and popular usage, of new types of communication systems. As a result of such advancements, for example, significant increases in the rates of data transmission have been made possible, and new types of communication services, making use of the increased data transmission rates, are possible.

Advancements in digital communication techniques are amongst the advancements in communication technologies which have permitted the increased data transmission rates and introduction of new types of communication services. When digital communication techniques are utilized, data which is to be communicated is digitized into digital form, and sometimes formatted into data packets. The data packets are communicated, either individually, or in groups, to a destination. Once received at the destination, the packets are concatenated together to recreate the informational content of the data of which the data packets are formed.

Radio communication systems are exemplary of communication systems which have benefited from advancements in communication technologies and in which digital communication techniques are increasingly utilized. A cellular communication system is an exemplary radio communication system. And, various standards have been promulgated pursuant to which different types of cellular communication systems have been constructed. Additional standard specifications continue to be promulgated relating both to improvements to existing cellular communication systems as well as new constructions of cellular communication systems. Standards relating to so-called, third-generation, cellular communication systems are presently being promulgated. Amongst the systems requirements proposed for the third-generation, cellular communication system are standards pertaining to codecs (coder-decoder) which are used at communication stations in a digital cellular communication system for speech, and other encoding, and decoding, operations. For instance, proposed codec standards set forth in a third-generation GERAN (GSM/EDGE radio access network) provides for AMR (adaptive multi-rate) functionality.

Initially, however, the standard relating to the AMR speech codec to be used in GSM (global system for mobile communications and third-generation (3G)) systems calls for a multi-mode codec with eight speech coding modes in which the modes exhibit bit-rates between 4.75 and 12.2 bps. Beneficial, mode-adaptation functionality is provided by such a speech codec. Adaptation of the mode in which the codec is operable permits dynamic balancing between speech coding and channel encoding to enable selection of the codec mode in a manner to provide best possible speech quality levels. As prevailing transmission conditions change, the codec mode is changeable, thereby to attain the best possible speech quality levels. However, proposed system standards relating to the third-generation GERAN set some constraints upon mode changes of the adaptive multi-rate codec. Namely, three significant constraints are set forth pursuant to AMR functionality in a GERAN-based system. First, only a maximum of four out of the eight coding modes are permitted to be in active use at a particular time. The modes in active use at a particular time form a set of modes, referred to as an active codec-mode set (ACS). And, limitations are placed upon when the mode is permitted to be changed. Changes are permitted only at alternate i.e., every other, frame defined in the communication system. Additionally, two channel-types are defined. An AMR (adaptive multi rate) full rate channel and an AMR half rate channel are defined. When the channel type is a half rate channel, the active codec mode set can contain only modes which exhibit bit rates beneath 8 bit/s.

Additional requirements set forth in the proposed specification define that the codec forming a portion of the mobile station be constructed to support all eight modes. At the network portion, only a subset of the modes are required to be supported. During call setup, an active codec-mode set is assigned at the network, typically at the base transceiver station, and the set includes a maximum of four modes.

Specifications pertaining to another multi-mode codec have also been set forth. This codec, referred to as an adaptive multi-rate wide band (AMR-WB) codec includes nine speech coding modes. The AMR-WB codec is to be operable upon sixteen kHz sampled signals, thereby enabling speech quality levels to exceed quality levels generally permitted pursuant to communications in a conventional PSTN (public-switched telephonic network). The constraints, noted above, with respect to mode changes are also applicable for the AMR-WB codec.

Packet-switched communications are provided for in the aforementioned specification. MIME type registrations for the codecs of the communication stations, using, e.g., RTP (real-time transmission protocol) -formatted packets.

Due to the inherent mobility of a mobile station, during a single communication session, communications with the mobile station may be handed-off between successive base transceiver stations of the radio access network portion of the radio communication system. The active codec-mode set may change subsequent to a handover between base transceiver stations. Additionally, the channel-type may be changed between full-rate and half-rate speech channels pursuant to the handover between base transceiver stations as well as an intra-base transceiver station handover. As a half-rate channel is unable to accommodate high adaptive multi-rate modes, a change in channel-type between a half-rate to a full-rate channel, and vice versa, might necessitate the change of the active codec-mode set.

While SIP/STP signaling can be used to communicate between end-points of a communication session, SIP signaling requires significant signaling capacity and, additionally, the codec modes forming the ACS might not be known when the SIP messages are required to be sent.

Accordingly, a manner is required by which to communicate the codec modes of the active codec-mode set so that the codecs of a sending and a receiving station pair can be operable to code and decode data during a communication session.

It is in light of this background information related to adaptive multi-rate codecs that the significant improvements of the present invention have evolved.

### SUMMARY OF THE INVENTION

The present invention, accordingly, advantageously provides apparatus, and an associated method, by which to synchronize operation of codecs at sending and receiving communication stations operable in a communication system, such as a third-generation, cellular communication system pursuant to a communication session.

Through operation of an embodiment of the present invention, a manner is provided by which to communicate indicia associated with an active codec-mode set pursuant to which codecs of the communication stations are operable.

In one aspect of the present invention, RTP (real-time protocol) messages are utilized to inform a receiving station of an active codec-mode set (ACS) pursuant to which the codec of the sending station is operable. An extension to existing real-time control protocol is used to provide an RTP message containing indicia associated with the active codec-mode set. In one implementation, an extension field is provided to an RTCP sender report (SR). An extension field is also definable in this implementation, to form a portion of an RTCP receiver report (RR). In another implementation, an application-specific RTCP packet type is defined which includes the indicia associated with the active codec-mode set.

In another aspect of the present invention, a special, or new, frame type (FT) field value is defined in the header portion of an RTP message. The value contained in the field type portion of the RTP header is of a value indicating that the frame includes indicia associated with the active codec-mode set. A separate RTP packet is, or alternatively is, separately sent to provide the active codec-mode set information.

In another aspect of the present invention, a codec-mode request (CMR) portion of the RTP header is selected to be of values which indicate a requested codec mode. The values of the CMR bits are interpreted such that a mobile station forming the sending station is able to send the requested, or any lower, mode in the active codec-mode set. By interpreting the CMR bits in this manner and defining the ACS of a holf rate channel, avoidance of end-to-end negotiations when a handover to, or from, a half rate channel occurs is permitted. That is to say, the ACS is renegotiable between the mobile station and the GERAN, but the information need not be communicated to the other endpoint of the communication session.

For example, if first, third, fifth, and seventh modes form the ACS for the FR (full rate) channel and the first, third, and fifth modes form the ACS of the HR (half rate) channel, then the seventh mode cannot be supported on the half rate channel. If, pursuant to a handover, the ACS is changed so that the seventh mode is no longer in the ACS, this need not be sent to the other end point with, e.g., SIG/SDP signaling. The other end point may continue to consider the seventh mode to belong to the ACS, but, ass the mobile station need not obey the CMR but can send any lower mode, and also request a lower mode, communications are effectuable.

In these and other aspects, therefore, apparatus, and an associated method, is provided for a communication system in which coded data, coded at a sending station by a sending-station codec is communicated to a receiving station and decoded thereat. Decoding is performed at the receiving station by a receiving station codec. Both the sending station codec and the receiving station codec are operable pursuant to an allowable set of codec-modes. Code-mode synchronization is facilitated between the sending station and the receiving station. A codec-mode detector is coupled to receive indications of a codec-mode of the allowable set of codec-modes pursuant to which the sending station codec is operated. A codec-mode message generator is coupled to the codec-mode detector to receive indications of the codec mode detected by the codec-mode detector. The codec-mode message generator generates a codec-mode update message at least when the codec-mode pursuant to which the sending station codec is operated changes.

A more complete appreciation of the present invention and to the scope thereof can be obtained from the accompanying drawings which are briefly summarized below, the following detailed description of the presently preferred embodiments of the invention, and the appended claims.

### BRIEF DESCRIPTION OF THE DRAWINGS

FIG. 1 illustrates a functional block diagram of a communication system in which an embodiment of the present invention is operable.

FIG. 2 illustrates a logical layer representation of portions of the communication system shown in FIG. 1, here representing packet header removal of packet headers from RTP (Real-Time Transport Protocol)—formatted data packets communicated during operation of the communication system.

FIG. 3 also illustrates a logical layer representation of portions of the communication system shown in FIG. 1, here representing header generation by which packet header information is added to data packets communicated during operation of the communication system.

FIG. 4 illustrates a representation of an adaptive multi-rate packet format illustrating fields utilized pursuant to an embodiment of the present invention.

FIG. 5 illustrates a message sequence diagram representative of signaling generated during operation of an embodiment of the present invention.

### DETAILED DESCRIPTION OF THE INVENTION

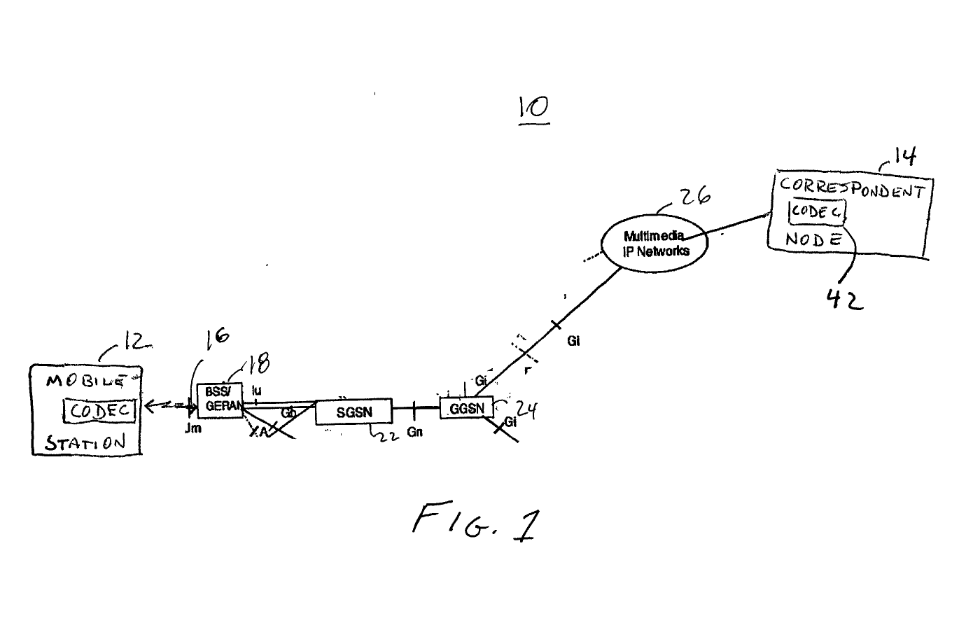

Referring first to FIG. 1, a communication system, shown generally a 10, provides for radio communication with a mobile station 12. Here, communications are effectuated pursuant to a communication session between the mobile station and a correspondent node 14. A communication path is formable between the correspondent node and the mobile station in which the communication path is defined upon a radio link 16, elements of a base station system and radio access network (BSS/GERAN) portion 18, an SGSN (Serving GPRS Service Node) 22, a GGSN (Gateway GPRS Service Node) 24, and an IP (Internet Protocol) Network 26.

The radio access network portion 18 includes network elements operable to permit the radio connection with the mobile station upon the radio link 16. In the exemplary implementation, the radio access network portion is generally constructed to be operable pursuant to a proposed GERAN (GSM/EDGE Radio Access Network) standard, as presently promulgated.

The SGSN 22 and the BSS/GERAN 18 are interfaced by an Iu interface, analogous to a UTRAN interface. Separately, the radio access network portion is connectable to a 2G (second generation) packet switched core network by way of a Gb interface or, for instance, a 2G mobile switching center by way of a A interface.

The mobile station includes a codec (coder/decoder) operable to perform coding and decoding operations, here shown at 38. Analogously, the correspondent node includes a codec 42 operable to perform corresponding functions.

In exemplary operation in which data originated at the mobile station is communicated to the correspondent node, the mobile station forms the sending station and the codec 38 forms the sending-station code. And, the correspondent node which receives the data forms the receiving station, and the codec 42 forms the receiving-station codec.

As two-way communications are effectuable between the mobile station and the correspondent node, the correspondent node also forms a sending station, and the mobile station also forms a receiving station. Description of operation of an embodiment of the present invention can analogously be described with respect to communication of data by the correspondent node to the mobile station.

The communication session here forms, e.g., a voice-over internet protocol (VoIP) communication session. Both the codecs 38 and 42 form adaptive multi-rate (AMR) or adaptive multi rate-wide band (AMR-WB) codecs capable of operating at any of more than one different modes. The different modes exhibit varying bit rates and the mode of operation of the codec is changeable on-the-fly. However, in some radio links, only a subset of the modes are capable of being in active use. Therefore, an active codec-mode set (ACS) is required.

In a GSM/EDGE radio link, here represented by the radio link 16, an active codec-mode set containing a maximum of four modes is enabled at any given time. Additionally, the active codec-mode set is independently set by the radio access network 18. Due to the mobility of the mobile station, a handover of communications might be performed during a communication session in which communications are handed off from one base transceiver station 28 to another. Pursuant to the handover of communications, the codec-modes contained in the codec-mode set might change during a single communication session.

As noted above, the codecs, such as the codec 38 positioned at the mobile station 12, is an AMR speech codec. The AMR speech codec is a multi-mode codec with eight speech coding modes having bit-rates ranging between 4.75 and 12.2 bps. A significant benefit of use of the ARM codec is mode adaptation functionality. Because the codec is operable in different speech-coding modes, adaptive selection of the mode of operation of the codec is selectable to provide a balance between speech coding and channel coding to it enable best possible speech quality for given transmission conditions. As the transmission conditions change, the mode is correspondingly changeable to maintain the balance. However, constraints are placed upon the mode changes pursuant to AMR functionality in a GERAN-based system, that is, the permissible operation of AMR over the GSM BSS. Namely, a maximum of four out of the eight coding modes can be in active use at any given time. Such four modes are referred to as the active codec-mode set. Additionally, the adaptive multi-rate mode can be changed only during every other frame defined in the communication system. And, two channel-types are defined, an AMR full-rate channel and an AMR half-rate channel. The half-rate channel is capable of containing only modes which exhibit bit-rates beneath 8 kbit/s. Furthermore, present promulgations of the 3GPP specification requires that a mobile station using an AMR codec must support all eight modes. But, the network elements need only support a subset of the eight modes. In practice, the base transceiver stations 28 of the radio access network assigned an active codec-mode set during call setup between the correspondent node and the mobile station. The active codec-mode set includes a maximum of four AMR modes.

As also noted above, the codec 38 might alternately be formed of an AMR-WB codec which includes nine speech coding modes. A wideband codec differs with the just-described codec in that the non-wideband codec is designed for compression of a traditional telephone bandwidth speech, using an eight kHz sampling frequency, while the wideband codec operates on 16 kHz sampled signals, so-called wideband speech, thus enabling speech quality to exceed that offered by current PSTN (Public-Switched Telephonic Networks). The same constraints noted above with respect to adaptive multi-rate mode changes are placed upon the wideband codec.

Speech transmission over the packet-switched network of which the communication system 10 is formed is realized through the use of RTP (real-time transmission protocol)-formatted packets. RTP packets are further encapsulated into a user data protocol (UDP) and internet protocol (IP) packets. Packet-switched speech transmission is generally referred to as voice-over IP (VoIP). The RTP control protocol (RTCP) is defined in the RTP specification. RTCP is used to monitor quality of service (QoS) and to give information about the participants of a communication session. RTCP packets are transmitted periodically, less often than transmission of RTP packets to limit the bandwidth consumptive RTCP traffic.

RTP transmission formats and MIME-type registrations for the codecs used in such communications have been proposed. Registration is required to enable usage of the codecs with SIP- and SDP-based call control. MIME registration includes use of a set of parameters which can be used to negotiate certain adaptive multi-rate and adaptive multi-rate wideband capabilities during a call setup preparatory to a communication session. Amongst the parameters are specifications on restrictions to mode changes.

Packet-switched speech communications, such as pursuant to VOIP communications, enables an increase in the effective use of radio capacity, and, hence, connectivity between the mobile station and the correspondent node. Present proposals for the packet-switched speech transmission makes us of SIP/SDP for call control and RTP/RTCP protocols for the transmission of speech data, also in the 3G network.

Proposals have been set forth to reuse existing AMR, and, possibly, also FR, channel coding designed primarily for circuit-switched radio communications for VoIP in a GSM/EDGE system. This is possible if the RTP/UDP/IP headers forming portions of the data packets communicated in a downlink direction are removed by the GERAN, i.e., by the radio access network portion 18 to the mobile station, and if the radio access network portion generates headers for the packets generated at the mobile station and sent in the uplink direction to the correspondent node. Such operations are referred to as header removal and header generation, respectively.

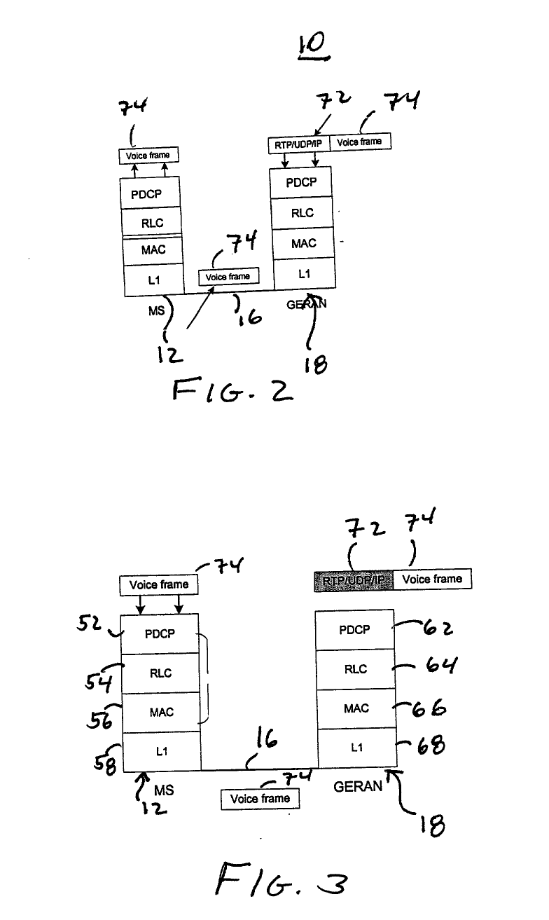

FIG. 2 illustrates the communication system 10 in logical-layer form, here showing the mobile station 12 and the GERAN portion 18. The mobile station is shown to include and PDCP layer 52 positioned upon an RLC layer 54. The RLC layer 54, in turn, is positioned upon a MAC layer 56. And, the MAC layer is positioned upon a lower layer, L1, 58. Analogously, the GERAN portion 18 includes corresponding layers, here the PDCP layer 62, an RLC layer 64, a MAC layer 56, and a lower layer L1, 68. The radio link 16 is also shown in the figure. Here, the RTP/UDP/IP headers 72, here shown to be followed by a voice frame 74, is routed to the radio access network portion 18. The headers are removed at the radio access network portion. This allows using channel coding schemes that have been optimized for specific speech frames, e.g., AMR formats. Effectively, through the removal of the header information, the RTP/UDP/IP protocol end-point is within the network. And, the radio access network 18 acts as a proxy server for the user-plane traffic RTP. In the control plane, i.e., the is planes 52 and 62 in the figure, SIP/SDP terminates at the mobile station 12.

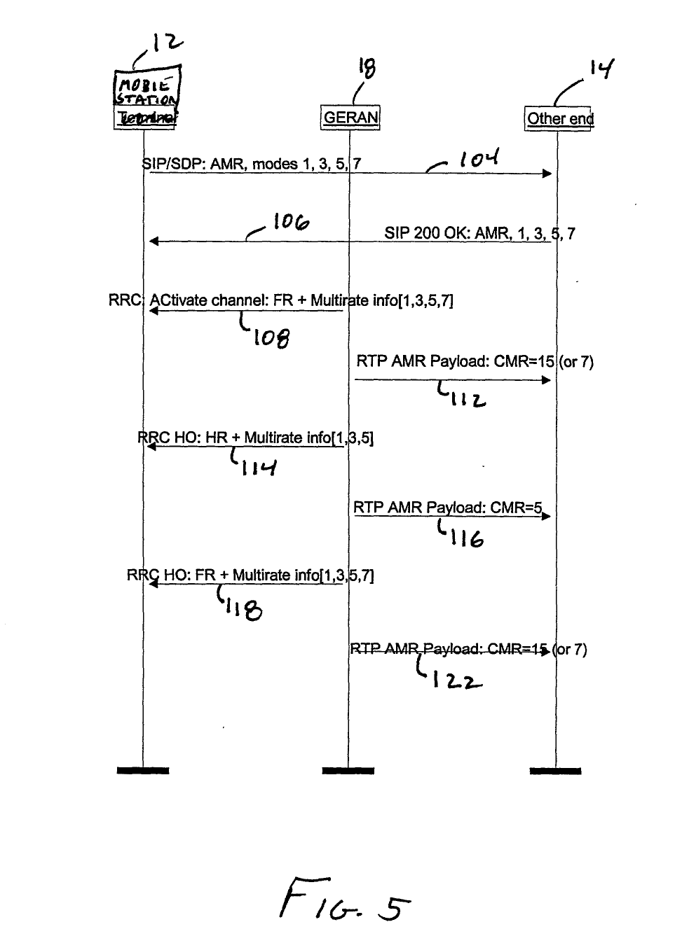

FIG. 4 again illustrates the mobile station 12 and the radio access network portion 18 in logical-layer form. Again, the mobile station is shown to be formed of the layers 52, 54, 56, and 58. And, the radio access network portion is again shown to be formed of the layers 62, 64, 66, and 68. Here, a voice frame 74, originated at the mobile station, is routed upon the radio link to the radio access network portion. Once the voice frame is received at the radio access network portion, the RTP/UDP/IP header information 72 is added to the voice frame to permit routing through the network to the correspondent node.

As noted previously the active codec set in the radio access network portion contains only four AMR modes at a time. Additionally, different portions of the radio access network, constructed by different vendors, might support different sets of codec modes. And, the active codec-mode set can be chosen independently for each connection, such as different connections to different base transceiver stations 28. As a result, different active codec-mode sets are likely to contain different combinations of codec modes. To permit appropriate communication of data between the mobile station and a correspondent node, however, it must be ensured that both of the communication stations have current information related to the codec modes that are to be used at any given time.

Additionally, when communications are handed off from one base transceiver station to another, there can also be a change in the channel type from a full rate speech channel to a half rate channel, a change might be made in conjunction both with the interbase station handover as well as an intrabase station handover. As the high rate channel is unable to accommodate the highest adaptive multi-rate modes, the change from half rate to full rate might well necessitate a change in the active codec-mode set. Changes from the full rate to the half rate channel might well require the change of the active codec-mode set, also.

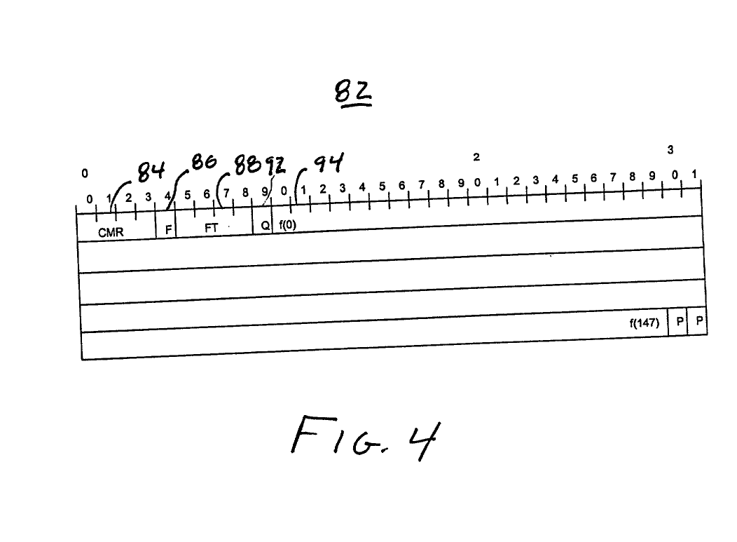

In one embodiment of the present invention, RTCP (realtime transport control protocol) is used to change and renegotiate the active codec-mode set during an RTP session. The RTP proxy in the header removal scenario set forth with respect to FIG. 2, and the corresponding header generation function set forth with respect to the description set forth in FIG. 3, sends RTCP packets containing information regarding the allowed codec modes. The mobile station does not participate in this signaling as the radio access network portion determines the active codec-mode set as well as acting as RTP proxy.

Pursuant to an embodiment of the present invention, the RTCP functionality is extended beyond regular RTCP sender reports (SR) and RTP receiver reports (RR) to include application/payload type specific feedback messages. In one implementation, an extension field to the RTP sender report or the RTCP receiver portion. In another implementation, an application-specific RTCP packet type is defined.

FIG. 4 illustrates an adaptive multi-rate packet format, shown generally at 82. The packet format includes a header portion, here shown to include a codec mode request (CMR) field 84, a frame (RF) field 86, a frame type (FT) indicator field 88, and a payload quality (Q) bit field indicator 92. A payload portion 94 of, here, 148 bits and padding bits 96 form the remainder of the AMR packet.

In another embodiment of the present invention, a specific frame type field value is inserted in the field 88 in the RTP header portion to indicate that the particular frame contains information about the allowed codec modes instead of the frame being a conventional AMR frame. This information is also sent by the radio access network 18, such as pursuant to the header removal/generation (RTP proxy) function. A specific value, for instance, thirteen, inserted into the frame type indicator field indicates that the payload portion 94 of the packet contains information about the allowed codec modes. The radio access network portion creates a separate RTP packet for sending this information, and the RTP packet is sent as part of an RTP voice stream.

FIG. 5 illustrates a message sequence diagram, shown generally at 102, representative of signaling generated during operation during another embodiment of the present invention. In this embodiment, the interpretation of the values contained in the CMR field 84 (shown in FIG. 4) is altered. As specified, the bit values of the CMR field indicate the requested codec mode. Pursuant to an embodiment of the present invention, the interpretation of the values of the bits of the CMR field are altered so that the mobile station is able to send a requested or any lower mode in the active codec-mode set. When the ACS of a half rate channel is defined as a subset of the ACS of a full rate channel, the proble of changing the modes of the ACS when a handover of the mobile station is effectuated from a full-rate to a half-rate channel in which the highest codec cannot be supported is circumvented. An exemplary scenario in which the default active codec-mode set contains modes 1, 3, 5, and 7 in which the mode 7 requires a full-rate physical channel while the others are operable with a half-rate channel is described in the message sequence diagram.

The segment 104 is representative of an SIP/SDP message sent from the mobile station 12 to the correspondent node 14 indicating the set containing such modes. The segment 106 is representative of an SRP 200 OK message of the AMR modes 1, 3, 5, and 7. Then, and as indicated by the segment 108, an activate channel message of full rate plus multi-rate information of modes 1, 3, 5, and 7 is communicated by the radio access network portion to the mobile station. And, the segment 112 is representative of an RTP message of an AMR payload; CMR equals 15 (or 7). The segment 114 is an RRCHO; HR plus multi-rate info (1, 3, 5) message. And, and RTP AMR payload; CMR equals 5, message indicated by the segment 116 is communicated by the radio access network portion to the correspondent node.

Then, and as indicated by the segment 118, an RRCHO: FR plus multi rate info (1, 3, 5, 7) message is communicated by the radio access network portion to the mobile station. And RTP message AMR payload: CMR equals 15 (or 7) indicated by the segment 122, is communicated to the correspondent node.

In case of a handover to a half rate channel, the mode 7 is unable to be supported due to the capacity of the half rate channel. To cope with the fact that one mode in the active codec-mode set is not available in the half-rate channel, the CMR bit in the message RTP AMR payload header is utilized so that it indicates that highest possible mode is in the ACS.

As an example, when CMR equals 5, the values are interpreted so that the highest possible mode is 5 and any mode above that cannot be received. The entity receiving this must obey it. When CMR equals 15 (or 7), such values are interpreted so that all the modes within the ACS are receivable.

If, for example, first, third, fifth, and seventh modes form the ACS for the FR (full rate) channel and the first, third, and fifth modes form the ACS of the HR (half rate) channel, then the seventh mode cannot be supported on the half rate channel. If, pursuant to a handover, the ACS is changed so that the seventh mode is no longer in the ACS, this need not be sent to the other end point with, e.g., SIG/SDP signaling. The other end point may continue to consider the seventh mode to belong to the ACS, but, ass the mobile station need not obey the CMR but can send any lower mode, and also request a lower mode, communications are effectuable.

With this change of CMR interpretation and with a proper choice of the ACS, it is possible to change the ACS in the GERAN by signaling between the mobile station and the GERAN but without requiring that the other endpoint, the correspondent node, be informed of the change.

Thereby, manners are provided by which to facilitate synchronization of the modes of the codecs of the sending and receiving stations operable pursuant to a communication session.

The previous descriptions are of preferred examples for implementing the invention, and the scope of the invention should not necessarily be limited by this description. The scope of the present invention is defined by the following claims.

What is claimed is:

1. In a communication system in which coded data, coded at a sending station by a sending-station codec, is communicated to a receiving station, and decoded thereat by a receiving station codec, both the sending-station codec and the receiving station codec operable pursuant to an allowable set of codec-modes, an improvement of apparatus for facilitating codec-mode synchronization between the sending station and the receiving station, said apparatus comprising:
a codec-mode detector coupled to receive indications of a codec-mode of the allowable set of codec-modes pursuant to which the sending-station codec is operated;
a codec-mode message generator coupled to receive indications of the codec-mode detected by said codec-mode detector, said codec-mode message generator for generating a codec-mode update message at least when the codec-mode pursuant to which the sending-station codec is operated changes.

2. The apparatus of claim 1 further comprising a codec-mode message detector coupled to the receiving-station codec, said codec-mode message detector for detecting values of the codec-mode message generated by said codec-mode message generator and for modifying the receiving station codec of the values detected thereat.

3. The apparatus of claim 1 wherein the communication system comprises a radio communication system having a radio access network (RAN) portion and wherein said codec-mode message generator is embodied at the RAN portion of the radio communication system

4. The apparatus of claim 3 wherein the radio communication system is represented in terms of logical-layger planes and wherein said codec-mode message generator is embodied at a PDCP (Packet Data Convergence Layer Plane) defined in the radio communication system.

5. The apparatus of claim 2 wherein the RAN portion of the radio communication system is operable pursuant to RTP (Radio Transport Protocol) protocol using RTCP (radio Transport Control Protocol) and wherein the codec-mode update message comprises an RTCP-formatted message.

6. The apparatus of claim 5 wherein the RTCP-formatted message forming the codec-mode update message includes an extension field and wherein the codec-mode update message is contained in the extension field of the RTCP formatted message.

7. The apparatus of claim 6 wherein the RTCP-formatted message forming the codec-mode update message comprises an RTCP Report message.

8. The apparatus of claim 5 wherein the RTCP-formatted message forming the codec-mode update message comprises an application-specific RTCP packet.

9. The apparatus of claim 2 wherein the RAN portion of the radio communication system is operable pursuant to RTP (Radio Transport Protocol) protocol and wherein the codec-mode update message comprises an RTP-formatted message, the RTP-formatted message including an RTP header portion, at least a portion of the codec-mode update message contained in the RTP header portion of the RTP-formatted message.

10. The apparatus of claim 9 wherein the RTP header portion comprises a frame type field, wherein the RTP-formatted message includes a payload portion, and wherein the frame type field is of a value indicating the RTP-formatted message to form the codec-mode update message.

11. The apparatus of claim 10 wherein the payload portion of the RTP-formatted message includes the codec-mode update message.

12. The apparatus of claim 2 wherein the communication system comprises a cellular communication system, wherein the sending-station comprises a mobile station and the receiving station comprises a correspondent node coupled to communicate with the mobile station, the sending-station codec selectably operable pursuant to any codec-mode of the allowable set and the receiving-station codec selectably operable pursuant to any codec-mode of a subset of the allowable set and wherein the codec-mode update message includes indicia of an active codec-mode set (ACS), the active codec-mode set identifying at least a portion of the subset of the allowable set.

13. The apparatus of claim 12 wherein the coded data communicated by the sending station to the receiving station selectably upon a half-rate channel and a full-rate channel and wherein the ACS of which the codec-mode update message is representative is selected responsive to which of the half-rate and full-rate channels, respectively, upon which the coded data is to be communicated.

14. The apparatus of claim 13 wherein the RAN portion of the radio communication system is operable pursuant to RTP (Radio Transport Protocol) protocol and wherein the codec-mode update message comprises an RTP-formatted message including an RTP header portion having a CMR (Codec Mode Request) portion, values of the CMR portion selected by said codec-mode message generator responsive to which the full-rate and half-rate channels upon which the coded data is to be communicated.

15. In a method for communicating coded data in a communication system, between a mobile station and a correspondent node by way of a RAN (radio access network), the mobile station and the correspondent node each having a codec for performing coding and decoding operations, both the codec of the mobile station and the codec of the correspondent node exhibiting AMR (adaptive multirate functionality), an improvement of a method for facilitating codec-mode synchronization by identifying an ACS (active codec-mode set), formed of at least a first codec mode pursuant to which the codec of the mobile station and the codec of the correspondent node are to be operable, said method comprising:
selecting at the RAN which of the at least first codec mode are to form the ACS; and
sending an RTCP (Tealtime Transport Control Protocol) message to the correspondent node containing indicia associated with the ACS selected during said operation of selecting.

16. In a method for communicating coded data in a communication system between a mobile station and a correspondent node by way of a RAN (radio access network), the mobile station and the correspondent node each having a codec for performing coding and decoding operations, both the codec of the mobile station and the codec of the correspondent node exhibiting AMR (adaptive multirate functionality), the coded data selectably communicated upon a channel-type formed of one of a full rate channel and a reduced-rate channel, an improvement of a method for facilitating codec-mode selection within an ACS (active codec-mode set), formed of at least a first codec mode, pursuant to which the codec of the mobile station and the codec of the correspondent node are to be operable upon change in the channel-type upon which the coded data is to be communicated, said method comprising:
identifying in an RTP message indicia indicating which of the at least the first codec mode are permitted to be used subsequent to the change in channel-type upon which the coded data is to be communicated; and
sending the RTP (Real time Transport Control Protocol) message in which the indicia is identified during said operation of identifying to the mobile station.

17. The method of claim 16 wherein the RTP message includes a CMR field and wherein the indicia in the RTP message indicating which of the first and at least second codec modes are permitted to be used identified during said operation of identifying is contained in the CMR field.

18. In a method for communicating in a communication system in which coded data, coded at a sending station by a sending-station codec, is communicated to a receiving station, and decoded thereat by a receiving station codec, both the sending-station codec and the receiving station codec operable pursuant to an allowable set of codec-modes, an improvement of a method for facilitating codec-mode synchronization between the sending station and the receiving station, said method comprising:
detecting indications of a codec-mode of the allowable set of codec-modes pursuant to which the sending-station codec is operated;
generating a codec-mode update message at least when the codec-mode pursuant to which the sending-station codec is operated changes.
